(19) United States
(12) Patent Application Publication
(10) Pub. No.: US 2019/0018281 A1
(43) Pub. Date: Jan. 17, 2019

(54) LIQUID CRYSTAL DISPLAY

(71) Applicant: SAMSUNG ELECTRONICS CO., LTD., Suwon-si (KR)

(72) Inventors: Sangah GAM, Seoul (KR); Beom Seok KIM, Seoul (KR); Ju Hyun KIM, Anyang-si (KR); Hyunseok CHOI, Seoul (KR)

(21) Appl. No.: 16/032,881

(22) Filed: Jul. 11, 2018

(30) Foreign Application Priority Data
Jul. 14, 2017 (KR) 10-2017-0089858

(51) Int. Cl. G02F 1/1335; G02F 1/13363; G02F 1/1337; G02F 1/1368; G02F 1/1362

(52) U.S. Cl. CPC G02F 1/133514; G02F 1/13363; G02F 1/1337; G02F 1/133602; G02F 1/1368; G02F 2001/133565; G02F 1/133528; G02F 2201/121; G02F 2201/123; G02F 2001/133548; G02F 1/136286

(57) ABSTRACT

A liquid crystal display includes a lower substrate and an upper substrate facing each other, a liquid crystal layer between the lower substrate and the upper substrate, a color conversion layer on the liquid crystal layer, a first polarizing layer and a first phase difference layer between the liquid crystal layer and the color conversion layer, and a second polarizing layer and a second phase difference layer between a light source and the lower substrate, where the first phase difference layer has refractive indexes satisfying Relationship Equation 1, and the second phase difference layer has refractive indexes satisfying Relationship Equation 2.

### CROSS-REFERENCE TO RELATED APPLICATION

This application claims priority to Korean Patent Application No. 10-2017-0089858, filed on Jul. 14, 2017, and all the benefits accruing therefrom under 35 U.S.C. § 119, the content of which in its entirety is herein incorporated by reference.

### BACKGROUND

### 1. Field

A liquid crystal display (“LCD”) is disclosed.

### 2. Description of the Related Art

A liquid crystal display (“LCD”) is a flat panel display that is widely used. The LCD includes two display panels including field generating electrodes and a liquid crystal layer interposed therebetween, and the liquid crystals in the liquid crystal layer rotate in response to an electric field formed between the field generating electrodes to thereby vary light transmittance and display an image.

The LCD displays color by combining light from a light source with a color filter. However, the color filter may absorb a large amount of light emitted from the light source and lower photoefficiency. It is therefore desirable to provide an LCD with improved photoefficiency.

Research regarding a photoluminescent liquid crystal display (“LCD”), which displays a color by using a light emitting element, instead of a color filter, has been conducted.

However, the photoluminescent LCD may not have a structure which includes a polarizing plate and a phase difference film disposed on the light emitting element, due to light-scattering characteristics of the light emitting element. Accordingly, the photoluminescent LCD may demonstrate a deteriorated contrast ratio and deteriorated display characteristics as compared with a liquid crystal display using a color filter.

### SUMMARY

An embodiment provides a liquid crystal display capable of increasing a contrast ratio of a photoluminescent LCD, thus improving display characteristics.

According to one embodiment, a liquid crystal display (LCD) includes a lower substrate and an upper substrate which face each other, a liquid crystal layer between the lower substrate and the upper substrate, a color conversion layer on the liquid crystal layer, a first polarizing layer and a first phase difference layer between the liquid crystal layer and the color conversion layer, and a second polarizing layer and a second phase difference layer between a light source and the lower substrate, where the first phase difference layer has refractive indexes satisfying Relationship Equation 1, and the second phase difference layer has refractive indexes satisfying Relationship Equation 2:

nₓ₁>n_{y1}>n_{z1} Relationship Equation 1

in Relationship Equation 1,

nₓ₁ is a refractive index at a slow axis of the first phase difference layer,

n_{y1} is a refractive index at a fast axis of the first phase difference layer, and

n_{z1} is a refractive index in a direction perpendicular to the slow axis and the fast axis of the first phase difference layer, and

nₓ₂>n_{y2}>n_{z2} Relationship Equation 2

in Relationship Equation 2,

nₓ₂ is a refractive index at a slow axis of the second phase difference layer,

n_{y2} is a refractive index at a fast axis of the second phase difference layer, and

n_{z2} is a refractive index in a direction perpendicular to the slow axis and the fast axis of the second phase difference layer.

In an exemplary embodiment, the first phase difference layer may have a retardation satisfying Relationship Equation 3:

45 nanometers (nm)≤Rₜₕ₁(450 nm)≤280 nm, Relationship Equation 3

in Relationship Equation 3,

Rₜₕ₁ (450 nm) is a thickness direction retardation of the first phase difference layer at a wavelength of 450 nm.

In an exemplary embodiment, the first phase difference layer may have a retardation satisfying Relationship Equation 4:

10 nm≤Rᵢₙ₁(450 nm)≤120 nm, Relationship Equation 4

in Relationship Equation 4, Rᵢₙ1 (450 nm) is an in-plane retardation of the first phase difference layer at the wavelength of 450 nm.

In an exemplary embodiment, the second phase difference layer may have a retardation satisfying Relationship Equation 5:

10 nm≤Rᵢₙ₂(450 nm)≤120 nm, Relationship Equation 5

in Relationship Equation 5, Rᵢₙ₂ (450 nm) is an in-plane retardation of the second phase difference layer at a wavelength of 450 nm.

In an exemplary embodiment, the second phase difference layer may have a retardation satisfying Relationship Equation 6:

5 nm≤Rₜₕ₂(450 nm)≤250 nm, Relationship Equation 6

in Relationship Equation 6, Rₜₕ₂ (450 nm) is a thickness direction retardation of the second phase difference layer at the wavelength of 450 nm.

In an exemplary embodiment, the refractive indexes of the second phase difference layer may satisfy Relationship Equation 2a and the second phase difference layer may have retardations satisfying Relationship Equation 7a:

nₓ₂>n_{y2}=n_{z2}, and Relationship Equation 2a

Rₜₕ₂(450 nm)/Rᵢₙ₂ (450 nm)<1, Relationship Equation 7a

in Relationship Equation 7a,

Rᵢₙ₂ (450 nm) is an in-plane retardation of the second phase difference layer at a wavelength of 450 nm, and

Rₜₕ₂ (450 nm) is a thickness direction retardation of the second phase difference layer at the wavelength of 450 nm.

In an exemplary embodiment, the refractive indexes of the second phase difference layer may satisfy Relationship Equation 2b:

Relationship Equation 2b

nₓ₂>n_{y2}>n_{z2}. In an exemplary embodiment, the first phase difference layer may be positioned between the liquid crystal layer and the first polarizing layer, and the second phase difference layer may be positioned between the lower substrate and the second polarizing layer.

In an exemplary embodiment, the color conversion layer may include a light emitting element which receives a first visible light from the light source and emits a second visible light.

In an exemplary embodiment, the first visible light may be blue light and the second visible light may be blue light, green light, red light, or a combination thereof.

In an exemplary embodiment, the light emitting element may include a quantum dot, a phosphor, or a combination thereof.

In an exemplary embodiment, the liquid crystal layer may include liquid crystals having negative birefringence.

In an exemplary embodiment, the liquid crystal layer may have a retardation satisfying Relationship Equation 8:

−360nm≤Rₜₕ_{_}_{cell}≤−250 nm, Relationship Equation 8

in Relationship Equation 8,

Rₜₕ_{_}_{cell} is a thickness direction retardation of the liquid crystal layer.

According to another embodiment, a liquid crystal display includes a first phase difference layer and a second phase difference layer, where one of the first phase difference layer and the second phase difference layer is inside a liquid crystal display panel, the other of the first phase difference layer and the second phase difference layer is outside the liquid crystal display panel, the first phase difference layer has refractive indexes satisfying Relationship Equation 1, the second phase difference layer has refractive indexes satisfying Relationship Equation 2:

nₓ₁>n_{y1}>n_{z1} Relationship Equation 1

in Relationship Equation 1,

nₓ₁ is a refractive index at a slow axis of the first phase difference layer,

n_{y1} is a refractive index at a fast axis of the first phase difference layer, and

n_{z1} is a refractive index in a direction perpendicular to the slow axis and the fast axis of the first phase difference layer, and

nₓ₂>n_{y2}≤n_{z2}, Relationship Equation 2

in Relationship Equation 2,

nₓ₂ is a refractive index at a slow axis of the second phase difference layer,

n_{y2} is a refractive index at a fast axis of the second phase difference layer, and

n_{z2} is a refractive index in a direction perpendicular to the slow axis and the fast axis of the second phase difference layer.

In an exemplary embodiment, the first phase difference layer may have a retardation satisfying Relationship Equation 3, and the second phase difference layer has a retardation satisfying Relationship Equation 5:

45 nm Rₜₕ₁ (450 nm)≤280 nm, and Relationship Equation 3

10 nm≤Rᵢₙ₂ (450 nm)≤120 nm, Relationship Equation 5

in Relationship Equation 3 or 5,

Rₜₕ₁ (450 nm) is a thickness direction retardation of the first phase difference layer at a wavelength of 450 nm, and

Rᵢₙ₂ (450 nm) is an in-plane retardation of the second phase difference layer at the wavelength of 450 nm.

In an exemplary embodiment, the refractive indexes of the second phase difference layer may satisfy Relationship Equation 2a and the second phase difference layer may have retardations satisfying Relationship Equation 7a:

nₓ₂>n_{y2}=n_{z2} Relationship Equation 2a

and

Rₜₕ₂ (450 nm)/Rᵢₙ₂ (450 nm)<1 , Relationship Equation 7a

in Relationship Equation 7a,

Rᵢₙ₂ (450 nm) is an in-plane retardation of the second phase difference layer at a wavelength of 450 nm, and

Rₜₕ₂ (450 nm) is a thickness direction retardation of the second phase difference layer at the wavelength of 450 nm.

In an exemplary embodiment, the refractive indexes of the second phase difference layer may satisfy Relationship Equation 2b.

nₓ₂>n_{y2}>n_{z2} Relationship Equation 2b

In an exemplary embodiment, the liquid crystal display panel may include a lower substrate and an upper substrate which face each other, a liquid crystal layer between the lower substrate and the upper substrate and which includes liquid crystals having negative birefringence, and a color conversion layer on the liquid crystal layer and which includes a light emitting element, where the first phase difference layer may be positioned between the liquid crystal layer and the color conversion layer inside the liquid crystal display panel.

In an exemplary embodiment, the liquid crystal display panel may further include a first polarizing layer between the first phase difference layer and the color conversion layer.

In an exemplary embodiment, the second phase difference layer may be outside the liquid crystal display panel. The liquid crystal display may further include a second polarizing layer positioned on or under the second phase difference layer.

A contrast ratio of a photoluminescent liquid crystal display (LCD) may be increased and display characteristics may be improved.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and other aspects, advantages and features of this disclosure will become more apparent by describing in further detail exemplary embodiments thereof with reference to the accompanying drawings, in which:

FIG. 1 is a schematic cross-sectional view showing a liquid crystal display (LCD) according to an embodiment;

FIG. 2 is a color diagram showing a distribution of luminance in a dark state of the liquid crystal display (LCD) according to Example 15;

FIG. 3 is a color diagram showing a distribution of luminance in a dark state of the liquid crystal display (LCD) according to Example 23;

FIG. 4 is a color diagram showing a distribution of luminance in a dark state of the liquid crystal display (LCD) according to Example 31;

FIG. 5 is a color diagram showing a distribution of luminance in a dark state of the liquid crystal display (LCD) according to Example 44;FIG. 6 is a color diagram showing a distribution of luminance in a dark state of the liquid crystal display (LCD) according to Example 46;

FIG. 7 is a color diagram showing a distribution of luminance in a dark state of the liquid crystal display (LCD) according to Example 49;

FIG. 8 is a color diagram showing a distribution of luminance in a dark state of the liquid crystal display (LCD) according to Comparative Example 1;

FIG. 9 is a color diagram showing a distribution of luminance in a dark state of the liquid crystal display (LCD) according to Comparative Example 2; and

FIG. 10 is a color diagram showing a distribution of luminance in a dark state of the liquid crystal display (LCD) according to Comparative Example 3.

### DETAILED DESCRIPTION

Exemplary embodiments will hereinafter be described in detail, and may be easily performed by those who have common knowledge in the related art. However, this disclosure may be embodied in many different forms and is not construed as limited to the example embodiments set forth herein.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, a liquid crystal display (LCD) according to an embodiment is described with reference to drawings.

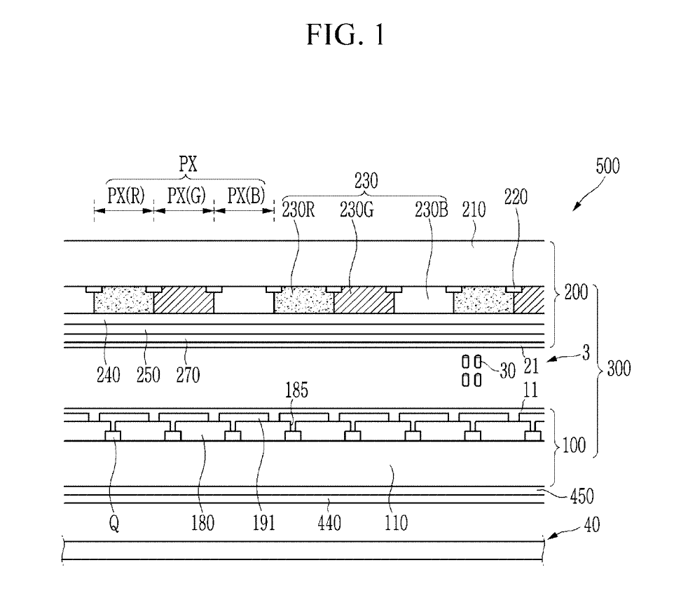

FIG. 1 is a schematic cross-sectional view of a liquid crystal display (“LCD”) according to an embodiment.

Referring to FIG. 1, the liquid crystal display 500 according to an embodiment includes a light source 40, a liquid crystal display panel 300, a lower polarizing layer 440, and a lower phase difference layer 450.

The light source 40 may be a planar light source, a dot light source, or a linear light source that supplies light to the liquid crystal display panel 300, and may be, for example, disposed in the form of an edge-type light source or a direct-type light source. The light source 40 may include a light emitting region including a light emitting element, a reflector disposed under the light emitting region and configured to reflect light emitted from the light emitting region, a light guide configured to supply the light emitted from the light emitting region toward the liquid crystal display panel 300 and/or to at least one optical sheet disposed on the light guide, but the light source 40 according to the invention is not limited thereto.

In an exemplary embodiment, the light emitting element may be, for example, a fluorescent lamp or a light emitting diode (“LED”), and, for example, may supply light having a wavelength in a visible wavelength region (hereinafter, referred to as “visible light”) such as blue light having relatively high energy.

The liquid crystal display panel 300 includes a lower display panel 100 disposed on the light source 40, an upper display panel 200 facing the lower display panel 100, and a liquid crystal layer 3 disposed between the lower display panel 100 and the upper display panel 200.

The lower display panel 100 includes a lower substrate 110, a plurality of wires (not shown), a thin film transistor Q, a pixel electrode 191, and an alignment layer 11.

In an exemplary embodiment, the lower substrate 110 may be, for example, an insulation substrate such as a glass substrate or a polymer substrate, and the polymer substrate may be made of, for example, a poly(ethylene terephthalate), poly(ethylene naphthalate), poly(carbonate), poly(meth)acrylate, poly(imide), or a combination thereof, but the lower substrate 110 according to the invention is not limited thereto.

A plurality of gate lines (not shown) that supply a gate signal and a plurality of data lines (not shown) that supply a data signal may be on the lower substrate 110 and may cross (e.g., intersect) one another, and a plurality of pixels PX is arranged in a form of a matrix defined by the gate lines and the data lines.

A plurality of thin film transistors Q is disposed on the lower substrate 110. The thin film transistors Q may include a gate electrode (not shown) connected to the gate lines, a semiconductor (not shown) overlapping with the gate electrode, a gate insulating layer (not shown) disposed between the gate electrode and the semiconductor, a source electrode (not shown) connected to the data lines, and a drain electrode (not shown) facing the source electrode in the center of the semiconductor. In FIG. 1, each pixel PX includes one thin film transistor Q, but the pixel PX according to the invention is not limited thereto. In another exemplary embodiment, two or more thin film transistors Q may be included in one pixel PX.

A protective layer 180 is disposed on the thin film transistor Q, and the protective layer 180 defines a contact hole 185 exposing the thin film transistor Q.

In an exemplary embodiment, the pixel electrode 191 is disposed on the protective layer 180. The pixel electrode 191 may be made of a transparent conductor such as indium tin oxide (“ITO”) or indium zinc oxide (“IZO”), and may be electrically connected to the thin film transistor Q through the contact hole 185. The pixel electrode 191 may have a predetermined pattern.

The alignment layer 11 is formed on the pixel electrode 191.

The upper display panel 200 includes an upper substrate 210, a color conversion layer 230, an upper polarizing layer 240, an upper phase difference layer 250, a common electrode 270, and an alignment layer 21.

In an exemplary embodiment, the upper substrate 210 may be, for example, an insulation substrate such as a glass substrate or a polymer substrate, and the polymer substrate may be made of, for example, polyethylene terephthalate, polyethylene naphthalate, polycarbonate, poly(meth)acrylate, polyimide, or a combination thereof, but the upper substrate 210 according to the invention is not limited thereto.

A light blocking member 220, also referred to as a black matrix, is disposed on the upper substrate 210. The light blocking member 220 may block light leakage between the pixel electrodes 191.

In addition, the color conversion layer 230 is disposed on the upper substrate 210. The color conversion layer 230 is configured to receive light having a predetermined wavelength and emits light having the same wavelength as the predetermined wavelength or light having a different wavelength from the predetermined wavelength to display one or more color. The color conversion layer 230 includes a photoluminescent material that is stimulated by light and emits light by itself (that is, a light emitting element). In an exemplary embodiment, the light emitting element may be, for example, a quantum dot, a phosphor, or a combination thereof.

For example, the light emitting element may emit light having the same wavelength as the light supplied by (e.g., received from) the light source 40. Alternatively, the light emitting element may emit light having a longer wavelength than the light supplied by (received from) the light source 40. For example, when the light received from the light source 40 is a blue light, the light emitting element may emit a blue light in the same wavelength region or may emit light in a longer wavelength region than the blue light, for example red light or green light. The light emitting element may emit two or more light selected from blue light, red light and green light

In this way, high photoconversion efficiency and low power consumption may be realized by the color conversion layer 230 including a light emitting element.

In addition, the color conversion layer 230 including the light emitting element may significantly reduce an amount of light lost due to the absorption of the light and thus increase photoefficiency, as compared to a color filter including a dye and/or a pigment which absorbs a considerable amount of light received from the light source and thus has low photoefficiency. In addition, color purity may be increased by an inherent luminous color of the light emitting element. Furthermore, the light emitting element emits light which is scattered in all directions and thus may improve viewing angle characteristics.

FIG. 1 shows a red conversion layer 230R including a red light emitting element configured to emit red light, a green conversion layer 230G including a green light emitting element configured to emit green light, and a blue conversion layer 230B including a blue light emitting element configured to emit blue light. For example, the red conversion layer 230R may emit light in a wavelength region ranging from greater than about 590 nanometers (nm) to less than or equal to about 700 nm, the green conversion layer 230G may emit light in a wavelength region ranging from about 510 nm to about 590 nm, and the blue conversion layer 230B may emit light in a wavelength region ranging from greater than or equal to about 380 nm to less than about 510 nm. However, the conversion layers according to the invention are not limited thereto. In another exemplary embodiment, for example, the light emitting element may be a light emitting element emitting cyan light, a light emitting element emitting magenta light, a light emitting element emitting yellow light, and/or a light emitting element emitting white light, or may additionally include at least one of these light emitting elements. In still another exemplary embodiment, for example, the light source 40 supplies blue light, and the blue conversion layer 230B does not include a separate light emitting element. The blue conversion layer 230B thus displays (e.g., emits) the blue light directly supplied from the light source 40. Herein, the blue conversion layer 230B may be empty or include a transparent insulator.

Here, pixel PX(R) is a pixel corresponding to the red conversion layer 230R, pixel PX(G) is a pixel corresponding to the green conversion layer 230G, and pixel PX(B) is a pixel corresponding to the blue conversion layer 230B.

The light emitting element may be, for example, a phosphor, a quantum dot, or a combination thereof.

In an exemplary embodiment, for example, the red conversion layer 230R may include a red phosphor including, Y₂O₂S:Eu, YVO₄:Eu,Bi, Y₂O₂S:Eu,Bi, SrS:Eu, (Ca,Sr)S:Eu, SrY₂S₄:Eu, CaLa₂S₄:Ce, (Sr,Ca,Ba)₃SiO₅:Eu, (Sr,Ca,Ba)₂Si₅N₈:Eu, (Ca,Sr)₂AlSiN₃:Eu, or a combination thereof. For example, the green conversion layer 230G may include a green phosphor including YBO₃:Ce,Tb, BaMgAl₁₀O₁₇:Eu,Mn, (Sr,Ca,Ba) (Al,Ga)₂S₄:Eu, ZnS:Cu,Al Ca₈Mg SiO₄₄Cl₂:Eu, Mn, Ba₂SiO₄:Eu, (Ba,Sr)₂SiO₄:Eu, Ba₂(Mg,Zn)Si₂O₇:Eu, (Ba,Sr)Al₂O₄:Eu, Sr₂Si₃O₈2SrCl₂:Eu, (Sr,Ca,Ba,Mg)P₂O₇N₈:Eu,Mn, (Sr,Ca,Ba,Mg)₃P₂O₈:Eu,Mn, Ca₃Sc₂Si₃O₁₂:Ce, CaSc₂O₄:Ce, b-SiAlON:Eu, Ln₂Si₃O₃N₄:Tb, (Sr,Ca,Ba)Si₂O₂N₂:Eu, or a combination thereof.

For example, the color conversion layer 230 may include a quantum dot. The quantum dot may be a semiconductor nanocrystal, and may have various shapes, for example an isotropic semiconductor nanocrystal, a quantum rod, a quantum plate, or a combination thereof. Herein, the quantum rod may indicate a quantum dot having an aspect ratio of greater than about 1, for example an aspect ratio of greater than or equal to about 2, greater than or equal to about 3, or greater than or equal to about 5. For example, the quantum rod may have an aspect ratio of less than or equal to about 50, less than or equal to about 30, or less than or equal to about 20. In an exemplary embodiment, the quantum dot may have, for example, an average particle diameter (e.g., an average largest particle diameter for a non-spherical shape) of about 1 nm to about 100 nm, about 1 nm to about 80 nm, about 1 nm to about 50 nm, or about 1 nm to 20 nm.

The quantum dot may control a light emitting wavelength depending on a size and/or a composition thereof. For example, the quantum dot may include a Group 12-Group 16 compound, a Group 13-Group 15 compound, a Group 14-Group 16 compound, a Group 14 compound, or a combination thereof. The Group 12-Group 16 compound may be, for example, a binary element compound including CdSe, CdTe, ZnS, ZnSe, ZnTe, ZnO, HgS, HgSe, HgTe, MgSe, MgS, or a combination thereof, a ternary element compound including CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, MgZnSe, MgZnS, or a combination thereof, and a quaternary element compound including HgZnTeS, CdZnSeS, CdZnSeTe, CdZnSTe, CdHgSeS, CdHgSeTe, CdHgSTe, HgZnSeS, HgZnSeTe, HgZnSTe, or a combination thereof. The Group 13-Group 15 compound may be, for example, a binary element compound including GaN, GaP, GaAs, GaSb, AlN, AlP, AlAs, AlSb, InN, InP, InAs, InSb, or a combination thereof, a ternary element compound including GaNP, GaNAs, GaNSb, GaPAs, GaPSb, AINP, AlNAs, AlNSb, AlPAs, AlPSb, InNP, InNAs, InNSb, InPAs, InPSb, GaAlNP, or a combination thereof, and a quaternary element compound including GaAlNAs, GaAlNSb, GaAIPAs, GaAlPSb, GaInNP, GaInNAs, GaInNSb, GaInPAs, GaInPSb, InAlNP, InAlNAs, InAlNSb, InAlPAs, InAlPSb, or a combination thereof. The Group 14-Group 16 compound may include, for example, a binary element compound including SnS, SnSe, SnTe, PbS, PbSe, PbTe, or a combination thereof, a ternary element compound including SnSeS, SnSeTe, SnSTe, PbSeS, PbSeTe, PbSTe, SnPbS, SnPbSe, SnPbTe, or a combination thereof, and a quaternary element compound including SnPbSSe, SnPbSeTe, SnPbSTe, or a combination thereof. The Group 14 compound may include, for example, a single-element compound including Si, Ge, or a combination thereof, and a binary element compound including SiC, SiGe, or a combination thereof. A combination comprising at least one of the foregoing may also be used.

The quantum dot may include the binary element compound, the ternary element compound, or the quaternary element compound in a substantially uniform concentration distribution (e.g., homogeneous distribution) or in different concentration distributions (e.g., heterogeneous distribution). The quantum dot may have a core-shell structure in which one quantum dot surrounds another quantum dot. For example, the core and the shell of the quantum dot may have an interface, and an element of the core, the shell, or a combination thereof, may have a concentration gradient, where the concentration of the element(s) of the shell decrease from an outer surface of the shell toward the core. For example, a material composition of the shell of the quantum dot has a higher energy bandgap than a material composition of the core of the quantum dot, and thereby the quantum dot may exhibit a quantum confinement effect. The quantum dot may have one core of a quantum dot and multiple shell layers surrounding the core (e.g., multi-shell structure). The multi-shell structure has at least two shells, where each shell may be a single composition, an alloy, or a shell having a concentration gradient. For example, a shell of the multi-shell structure that is furthest away from the core may have a higher energy bandgap than a shell that is nearest to the core, and thereby the quantum dot may exhibit a quantum confinement effect.

In an exemplary embodiment, the quantum dot may have a quantum yield of greater than or equal to about 10 percent (%), for example greater than or equal to about 30%, greater than or equal to about 50%, greater than or equal to about 60%, greater than or equal to about 70%, or greater than or equal to about 90%, but the quantum dot according to the invention is not limited thereto. The quantum dot has a relatively narrow spectrum. For example, the quantum dot may have a full width at half maximum (“FWHM”) of a light emitting wavelength region of less than or equal to about 45 nm, for example less than or equal to about 40 nm, or less than or equal to about 30 nm.

The quantum dot may be included in the color conversion layer 230 in a form of a quantum dot-polymer composite, where the quantum dot is dispersed in the polymer. The polymer may act as a matrix of the quantum dot-polymer composite, and the polymer is not particularly limited as long as it does not quench the quantum dot. The polymer may be a transparent polymer, including, for example, a poly(vinylpyrrolidone), poly(styrene), poly(ethylene), poly(propylene), poly(methyl acrylate), poly(methyl methacrylate), poly(butyl methacrylate) (PBMA), a copolymer thereof, or a combination thereof, but the polymer according to the invention is not limited thereto. The quantum dot-polymer composite may have a single layer or a multi-layer structure.

The upper polarizing layer 240 is disposed on a surface of the color conversion layer 230.

The upper polarizing layer 240 may be an in-cell polarizing layer positioned inside the liquid crystal display panel 300 and may be disposed on a lower entire surface of the color conversion layer 230. In other words, the upper polarizing layer 240 may be disposed under the color conversion layer 230 and be configured to supply polarized light to the color conversion layer 230.

In this way, since the upper polarizing layer 240 is disposed inside the liquid crystal display panel 300 and under the color conversion layer 230, and since a separate polarizing plate attached outside the liquid crystal display panel 300 and disposed on the color conversion layer 230 opposite to the upper polarizing layer 240 is not present, light emitted from the light emitting element of the color conversion layer 230 is not influenced by the separate polarizing plate, and as a result, a contrast ratio may be improved. In other words, since the light emitting element of the color conversion layer 230 may emit scattered light which is not polarized in a particular direction, if a polarizing plate is disposed on the color conversion layer 230 so that the scattered light passes through the polarizing plate, luminance of the light passing through the polarizing plate in a bright state may be greatly reduced compared with the scattered light, and thus a contrast ratio may be lowered. In addition, an effect of improving a viewing angle of a liquid crystal display (LCD) may not be hindered by the scattered light emitted from the light emitting element of the color conversion layer 230, but instead may be maintained.

Accordingly, an LCD including the upper polarizing layer 240 used as an in-cell polarizing layer may prevent discoloring or image distortion due to an influence of a polarizing plate, attached outside a liquid crystal display panel and disposed on the color conversion layer 230 opposite to the upper polarizing layer 240, on light emitted from the light emitting element. Also, the LCD including the upper polarizing layer 240 used as the in-cell polarizing layer may maintain inherent light emitting characteristics of the light emitting element and thus secure high color purity while simultaneously reducing a light loss. In addition, the in-cell polarizing layer is a very thin film having a thickness of less than or equal to about 1 micrometer (μm) and thus may reduce an overall thickness of a liquid crystal display (LCD).

The upper polarizing layer 240 may be a linear polarizer that converts light emitted from the light source 40 and passed through the liquid crystal layer 3, into linear polarized light.

For example, the upper polarizing layer 240 may be made of elongated polyvinyl alcohol (“PVA”). The elongated PVA may be made, for example, according to a method of elongating a polyvinyl alcohol film, adsorbing iodine or a dichroic dye thereto, and borating and washing the same.

For example, the upper polarizing layer 240 may be a polarizing film prepared, by mixing a polymer and a dichroic dye and melt-blending the mixture at a temperature above the melting point of the polymer. The polymer may be a hydrophobic polymer, for example a poly(olefin).

For example, the upper polarizing layer 240 may be a wire grid polarizer. The wire grid polarizer has a structure in which a plurality of metal wires is aligned in one direction, and accordingly, when incident light passes through the wire grid polarizer, light parallel to a metal wire is absorbed or reflected, but light perpendicular to a metal wire is transmitted and may form linear polarized light. Herein, the linear polarized light may be more efficiently formed when a wavelength of light is wider than a gap between the metal wires. The wire grid polarizer may be appropriately applied as the in-cell polarizing layer and also may be thin, and thus a liquid crystal display (LCD) 500 including the wire grid polarizer as the upper polarizing layer 240 may be thin.

The upper phase difference layer 250 is disposed on a surface of the upper polarizing layer 240.

The upper phase difference layer 250 may be an in-cell phase difference layer positioned inside the liquid crystal display panel 300. In an exemplary embodiment, for example, the upper phase difference layer 250 may contact the upper polarizing layer 240. In another exemplary embodiment, for example, a layer (not shown) may be disposed between the upper phase difference layer 250 and the upper polarizing layer 240, and may include an insulating layer such as silicon oxide and silicon nitride.

When the upper phase difference layer 250 is functionally combined with a lower phase difference layer 450 outside a lower display panel 100 to adjust light retardation, a light leakage from the side direction, which occurs before light reaches the color conversion layer 230 in a dark state, may be reduced or prevented. Also, an unnecessary light emission of the color conversion layer 230 in the dark state may be reduced, and accordingly, luminance in a dark state may be decreased, and thus a contrast ratio may be improved.

The upper phase difference layer 250 may include a heat resistant polymer, a heat resistant liquid crystal, or a combination thereof. In an exemplary embodiment, the heat resistant polymer may include, for example, a polymer having a glass transition temperature (Tg) of greater than or equal to about 150° C., and may include, for example, polyimide, polyamic acid, polyamide, polycarbonate, cycloolefin, or a combination thereof, but the heat resistant polymer according to the invention is not limited thereto. In another exemplary embodiment, for example, the heat resistant polymer may have a glass transition temperature (Tg) of greater than or equal to about 180° C., greater than or equal to about 200° C., greater than or equal to about 220° C., or greater than or equal to about 230° C.

For example, the upper phase difference layer 250 may include a liquid crystal layer made of liquid crystals having positive or negative birefringence and may further include an alignment layer on a surface of the liquid crystal layer. For example, the upper phase difference layer 250 may be a homeotropic liquid crystal layer.

For example, the upper phase difference layer 250 may be provided with a predetermined phase difference by elongating a film made of a heat resistant polymer in a uniaxial or biaxial direction. In an exemplary embodiment, for example, the upper phase difference layer 250 may be endowed with a predetermined retardation to induce linear or surface alignment of a heat resistant polymer or a heat resistant liquid crystal during the drying step, when the heat resistant polymer or the heat resistant liquid crystal is prepared as a solution and then, coated and dried.

The common electrode 270 is disposed on a surface of the upper phase difference layer 250. The common electrode 270 may be, for example, made of a transparent conductor such as ITO or IZO and disposed on an entire surface of the upper phase difference layer 250. The common electrode 270 has a predetermined pattern.

The alignment layer 21 is disposed on one surface of the common electrode 270.

The liquid crystal layer 3 including a plurality of liquid crystals 30 is disposed between the lower display panel 100 and the upper display panel 200. The liquid crystals 30 may have positive or negative dielectric anisotropy. For example, the liquid crystal 30 may have negative dielectric anisotropy. For example, the liquid crystal 30 may be aligned in a substantially vertical direction to the surfaces of the substrates 110 and 210 when an electric field is not applied to the pixel electrode 191 and the common electrode 270 (i.e., in the absence of an electric field). Thereby, the liquid crystal display (LCD) 500 may be a vertical alignment liquid crystal display (LCD).

In an exemplary embodiment, the lower polarizing layer 440 may be attached to an outer surface of the lower display panel 100 and may be disposed between the lower display panel 100 and the lower phase difference layer 450. The lower polarizing layer 440 may be a linear polarizer and is configured to polarize light supplied from the light source 40 and to supply the polarized light to the liquid crystal layer 3.

For example, the lower polarizing layer 440 may be made of elongated polyvinyl alcohol (PVA) prepared according to a method of, for example, elongating a polyvinyl alcohol film, adsorbing iodine or a dichroic dye thereto, and borating and washing the same.

For example, the lower polarizing layer 440 may be a polarizing film prepared by mixing a polymer and a dichroic dye and melt-blending the polymer with the dichroic dye at a temperature greater than the melting point of the polymer. The polymer may be a hydrophobic polymer, for example polyolefin.

For example, the lower polarizing layer 440 may be a wire grid polarizer. The wire grid polarizer may be combined with the upper polarizing layer 240 to realize a thin liquid crystal display (LCD) 500.

In another exemplary embodiment, the lower phase difference layer 450 may be attached to an outer surface of the lower display panel 100 and may be disposed between the lower display panel 100 and the lower polarizing layer 440. The lower phase difference layer 450 may be one layer or two or more layers.

As described above, the contrast ratio may be improved by functionally combining the upper phase difference layer 250 with the lower phase difference layer 450 to adjust light retardation and thus reduce or prevent light leakage at the side before light reaches the color conversion layer 230 in a dark state, and accordingly, reduce the unnecessary light emission of the color conversion layer 230 in the dark mode and thereby decrease luminance in a dark state. The combination of the upper phase difference layer 250 with the lower phase difference layer 450 may be variously designed to reduce the light leakage and increase the contrast ratio.

In an exemplary embodiment, for example, the upper phase difference layer 250 may have a refractive index satisfying Relationship Equation 1, and the lower phase difference layer 450 may have, for example, a refractive index satisfying Relationship Equation 2.

nₓ₁>n_{y1}>n_{z1}

In Relationship Equation 1,

nₓ₁ is a refractive index in a direction having a highest in-plane refractive index of the upper phase difference layer 250 (hereinafter referred to as a “slow axis”),

n_{y1} is a refractive index in a direction having a lowest in-plane refractive index of the upper phase difference layer 250 (hereinafter, referred to as a “fast axis”), and

n_{z1} is a refractive index in a direction perpendicular to the slow axis and fast axis of the upper phase difference layer 250.

nₓ₂>n_{y2}≥n_{z2} Relationship Equation 2

In Relationship Equation 2,

nₓ₂ is a refractive index at a slow axis of the lower phase difference layer 450,

n_{y2} is a refractive index at a fast axis of the lower phase difference layer 450, and

n_{z2} is a refractive index in a direction perpendicular to the slow axis and the fast axis of the lower phase difference layer 450.

The compensation function to reduce viewing angle dependency may be efficiently performed by combining the upper phase difference layer 250 satisfying Relationship Equation 1 and the lower phase difference layer 450 satisfying Relationship Equation 2.

Retardation of a phase difference layer may be expressed as an in-plane retardation (Rᵢₙ) and a thickness direction retardation (Rₜₕ₁).

For example, the upper phase difference layer 250 may be expressed as an in-plane retardation (“Rᵢₙ₁”) and a thickness direction retardation (“Rₜₕ₁”), and the in-plane retardation (Rᵢₙ₁) of the upper phase difference layer 250 is retardation generated in an in-plane direction of the upper phase difference layer 250 and may be represented by Rᵢₙ₁=(nₓ₁−n_{y1})×d₁. The thickness direction retardation (Rₜₕ₁) of the upper phase difference layer 250 is retardation generated in a thickness direction of the upper phase difference layer 250 and may be represented by Rₜₕ₁={[(nₓ₁+n_{y1})/2]−n_{z1}}×d₁. Herein, d₁ denotes a thickness of the upper phase difference layer 250. The upper phase difference layer 250 may have the in-plane retardation and the thickness direction retardation within a predetermined range by variously changing the nₓ₁, n_{y1}, n_{z1}, and/or the thickness (d₁).

For example, the lower phase difference layer 450 may be expressed as an in-plane retardation (“Rᵢₙ₂”) and a thickness direction retardation (“Rₜₕ₂”), and the in-plane retardation (Rᵢₙ₂) of the lower phase difference layer 450 is retardation generated in an in-plane direction of the lower phase difference layer 450 and may be represented by Rᵢₙ₂=(nₓ₂−n_{y2})×d₂. The thickness direction retardation (Rₜₕ₁) of the lower phase difference layer 450 is retardation generated in a thickness direction of the lower phase difference layer 450 and may be represented by Rₜₕ₂={[(nₓ₂+n_{y2})/2]−n_{z2}}×d₂. Herein, d₂ denotes a thickness of the lower phase difference layer 450. The lower phase difference layer 450 may have the in-plane retardation and the thickness direction retardation within a predetermined range by variously changing the nₓ₂, n_{y2}, n_{z2}, and/or the thickness (d₂).

In an exemplary embodiment, for example, the upper phase difference layer 250 satisfying the Relationship Equation 1 may have retardations satisfying Relationship Equations 3 and 4.

45 nm≤Rₜₕ₁(450 nm)≤280 nm, and Relationship Equation 3

10 nm≤Rᵢₙ₁(450 nm)≤120 nm. Relationship Equation 4

In Relationship Equations 3 and 4,

Rₜₕ₁ (450 nm) is a thickness direction retardation of the upper phase difference layer 250 at a wavelength of 450 nm, and

Rᵢₙ₁ (450 nm) is an in-plane retardation of the upper phase difference layer 250 at a wavelength of 450 nm.

Herein, the retardation is mentioned at a wavelength of 450 nm as a reference wavelength, but when a light emitting wavelength of the light source is changed, the reference wavelength may be changed and retardation may be also changed. For example, the retardation and the reference wavelength may be set to satisfy the following relationship: 0.1×λ_{BL} (nm)≤Rₜₕ(λ_{BL})≤0.63×λ_{BL} (nm) (here, λ_{BL} (nm) is a maximum light emitting wavelength of a light source), 0.12×λ_{BL} (nm) Rₜₕ(λ_{BL})≤0.63×λ_{BL} (nm), or 0.14×λ_{BL} (nm)≤Rₜₕ(λ_{BL})≤0.70 ×λ_{BL} (nm), but the retardation and the reference wavelength according to the invention is not limited thereto.

In another exemplary embodiment, for example, the upper phase difference 250 may have the thickness direction retardation satisfying Relationship Equation 3a:

50 nm≤Rₜₕ₁ (450 nm) 260 nm. Relationship Equation 3a

In still another exemplary embodiment, for example, the upper phase difference 250 may have the thickness direction retardation satisfying Relationship Equation 3b:

60 nm≤Rₜₕ₁ (450 nm)≤240 nm. Relationship Equation 3b

In still another exemplary embodiment, for example, the upper phase difference 250 may have the thickness direction retardation satisfying Relationship Equation 3c:

70 nm≤Rₜₕ₁(450 nm)≤225 nm. Relationship Equation 3c

The compensation function may be performed more efficiently by satisfying above-mentioned Relation Equations.

In an exemplary embodiment, for example, the lower phase difference layer 450 satisfying the Relationship Equation 2 may have retardations satisfying Relationship Equations 5 and 6.

10 nm≤Rᵢₙ₂(450 nm)≤120 nm, and Relationship Equation 5

5 nm≤Rₜₕ₂(450 nm)≤250 nm Relationship Equation 6

In Relationship Equations 5 and 6,

Rᵢₙ₂ (450 nm) is an in-plane retardation of the lower phase difference layer 450 at a wavelength of 450 nm, and

Rₜₕ₂ (450 nm) is a thickness direction retardation of the lower phase difference layer 450 at a wavelength of 450 nm.

The compensation function may be performed more efficiently by satisfying above-mentioned Relation Equations.

For example, the lower phase difference 450 may have a refractive index satisfying Relationship Equation 2a:

nₓ₂>n_{y2}=n_{z2} Relationship Equation 2

In Relationship Equation 2a, n_{y2} and n_{z2} may be substantially equivalent, or completely the same, and herein, regarded as substantially equivalent when the difference of refractive indexes between n_{y2} and n_{z2} is, for example, less than or equal to about 0.02, or less than or equal to about 0.01.

For example, the lower phase difference layer 450 satisfying the Relationship Equation 2a may have retardations satisfying Relationship Equations 5a and 6a.

10 nm≤Rᵢₙ₂(450 nm)≤110 nm, and Relationship Equation 5a

5 nm ≤Rₜₕ₂(450 nm )≤55 nm Relationship Equation 6a

In the lower phase difference layer 450 satisfying the Relationship Equation 2a, the in-plane retardation Rᵢₙ₂ may be greater than the thickness direction retardation Rₜₕ₂ at a predetermined wavelength, and, for example, the lower phase difference layer 450 may satisfy Relationship Equation 7a:

Rₜₕ₂(450 nm)/Rᵢₙ₂ (450 nm)<1 Relationship Equation 7a

In another exemplary embodiment, for example, the lower phase difference layer 450 may satisfy Relationship Equation 7a-1:

0<Rₜₕ₂ (450 nm)/Rᵢₙ₂ (450 nm)<0.8. Relationship Equation 7a-1

In still another exemplary embodiment, for example, the lower phase difference layer 450 may satisfy Relationship Equation 7a-2:

0<Rₜₕ₂ (450 nm)/Rᵢₙ₂ (450 nm) 0.7. Relationship Equation 7a-2

In still another exemplary embodiment, for example, the lower phase difference layer 450 may satisfy Relationship Equation 7a-3:

0<Rₜₕ₂ (450 nm)/Rᵢₙ₂ (450 nm)≤0.5. Relationship Equation 7a-3

For example, the lower phase difference layer 450 may have a refractive index satisfying Relationship Equation 2b:

nₓ₂>n_{y2}>n_{z2} Relationship Equation 2b

For example, the lower phase difference layer 450 satisfying the Relationship Equation 2b may have retardations satisfying Relationship Equations 5b and 6b:

10 nm≤Rᵢₙ₂ (450 nm) 120 nm, and Relationship Equation 5b

45 nm≤Rₜₕ₂ (450 nm)≤240 nm. Relationship Equation 6b

For example, the liquid crystal layer 3 may have a retardation satisfying Relationship Equation 8:

−360 nm≤Rₜₕ_{_}_{cell}≤−250 nm, Relationship Equation 8

In Relationship Equation 8,

Rₜₕ_{_}cell is a thickness direction retardation of the liquid crystal layer 3. According to the embodiment, the liquid crystal display (LCD) 500 displays a color by using the color conversion layer 230 including a light emitting element and thus may increase photoefficiency and improve color characteristics.

In addition, light characteristics and viewing angle characteristics of the color conversion layer 230 including a light emitting element may be secured, and thus display characteristics may be improved by introducing an upper polarizing layer 240 and an upper phase difference layer 250 inside a liquid crystal display panel 300, but omitting a polarizer and a phase difference film on the outside of an upper substrate 210 to prevent deterioration of light characteristics and color characteristics which are attributed to the presence of the polarizer and the phase difference film on the outside of the upper substrate 210.

In addition, the upper polarizing layer 240 and the upper phase difference layer 250 are thin and thus may be used to manufacture a thin liquid crystal display (LCD) 500.

In addition, the contrast ratio may be improved by functionally combining the upper phase difference layer 250 with the lower phase difference layer 450 to adjust light retardation and thus reduce or prevent light leakage at the side before light reaches the color conversion layer 230 in a dark state, and accordingly, the combination may reduce the unnecessary light emission of the color conversion layer 230 in the dark state and thereby decrease luminance in a dark state.

Although the upper phase difference layer 250 satisfying Relationship Equation 1 and the lower phase difference layer 450 satisfying Relationship Equation 2 are mentioned, the upper phase difference layer 250 and the lower phase difference layer 450 according to the invention are not limited thereto. In another exemplary embodiment, the lower phase difference layer 450 satisfying Relationship Equation 1 and the upper phase difference layer 250 satisfying Relationship Equation 2 may be used.

Hereinafter, the aforementioned embodiments are illustrated in more detail through the examples. However, these examples are exemplary, and the present disclosure is not limited thereto.

### Optical Simulation

The following structures of a liquid crystal display (LCD) 500 are simulated and optical simulations are performed.

The optical simulations are performed using a TECHWIZ LCD™ simulation software program of Sanayi System Co., Ltd. to obtain a luminance distribution in a dark state at a wavelength of 450 nm and at an azimuthal angle of 0° to about 360° and a side angle of 0° to about 90° and to calculate its average.

### Example I

An optical simulation based upon a liquid crystal display (LCD) including an upper substrate (e.g., a glass substrate), an upper polarizing layer, an upper phase difference layer, a homeotropic liquid crystal layer, a lower substrate (e.g., a glass substrate), a lower phase difference layer, a lower polarizing layer, and a blue light source arranged with this order from the observer, is performed. Input variables of each layer are as follows.

Refractive indexes of the upper and lower substrates (e.g., glass substrates): 1.5.

Thicknesses of the upper and lower substrates (e.g., glass substrates): 500 μm.

Transmittance of the upper and lower polarizing layers: 42.45%.

Degrees of polarization of the upper and lower polarizing layers: 99.99%.

Refractive index (ne, no) of the homeotropic liquid crystal layer:
ne=1.6163 and no=1.4956.

Average refractive index of the upper phase difference layer: 1.60.

nx-nz of the upper phase difference layer: 0.052.

Average refractive index of the lower phase difference layer: 1.65.

nx-nz of the lower phase difference layer: 0.0026.

Blue light source: short wavelength light source of 450 nm.

The optical simulations are performed within various ranges satisfying the following optical conditions.

Homeotropic liquid crystal layer: Rₜₕ=−295 nm,

Upper phase difference layer: nₓ₁>n_{y1}>n_{z1}, Rᵢₙ₁=10 to 80 nm, Rₜₕ₁=45 to 280 nm, and

Lower phase difference layer: nₓ₂>n_{y2}=n_{z2}, Rᵢₙ₂=10 to 110 nm, Rₜₕ₂=5 to 240 nm

### Example II

An optical simulation is performed using the same liquid crystal display (LCD) as Example 1 except for changing the optical conditions of the lower phase difference layer as follows.

Lower phase difference layer: nₓ₂>n_{y2}>n_{z2}, Rᵢₙ₂=10 to 110 nm, Rₜₕ₂ =5 to 240 nm.

Average refractive index of the lower phase difference layer: 1.54.

### Comparative Example 1

An optical simulation is performed using the same liquid crystal display (LCD) as Example 1 except that the upper phase difference layer and the lower phase difference layer are not included.

### Comparative Example 2

An optical simulation is performed using the same liquid crystal display (LCD) as Example 1 except that the upper phase difference layer is not included and the optical condition of the lower phase difference layer is changed as follows.

Lower phase difference layer: nₓ₂>n_{y2}=n_{z2}, Rᵢₙ₂=120 nm, Rₜₕ₂=60 m.

### Comparative Example 3

An optical simulation is performed using the same liquid crystal display (LCD) as Example 1 except that the upper phase difference layer is not included and the optical condition of the lower phase difference layer is changed as follows.

Lower phase difference layer: nₓ₂>n_{y2}>n_{z2}, Rᵢₙ₂=65 nm, Rₜₕ₂=250 nm.

### Evaluation

The optical simulation results are obtained as a luminance distribution in a dark state at a wavelength of 450 nm and at an azimuthal angle from 0° to 360° and a side angle of 0° to 90°.

A sum of the luminance in a dark state at all the azimuthal angles and all the side angles may be proportional to a light dose reaching a color conversion layer in a dark state, and as the sum of the luminance in a dark state is smaller in the dark state, a light dose emitted by the color conversion layer in the dark state is decreased, and thus the luminance in a dark state may be lowered. Accordingly, as the luminance in a dark state is lowered, a liquid crystal display (LCD) may be expected to have a higher contrast ratio.

The average luminance in a dark state may be obtained by averaging each luminance in a dark state at all the azimuthal angles and all the side angles. As the average luminance in a dark state is lowered, a liquid crystal display (LCD) may be expected to have a higher contrast ratio.

Table 1 shows average luminance in a dark state of the liquid crystal displays (LCD) according to Examples 1 to 42 and Comparative Examples 1 and 2, and Table 2 shows average luminance in a dark state of the liquid crystal displays (LCD) according to Examples 43 to 62 and Comparative Examples 1 and 3.

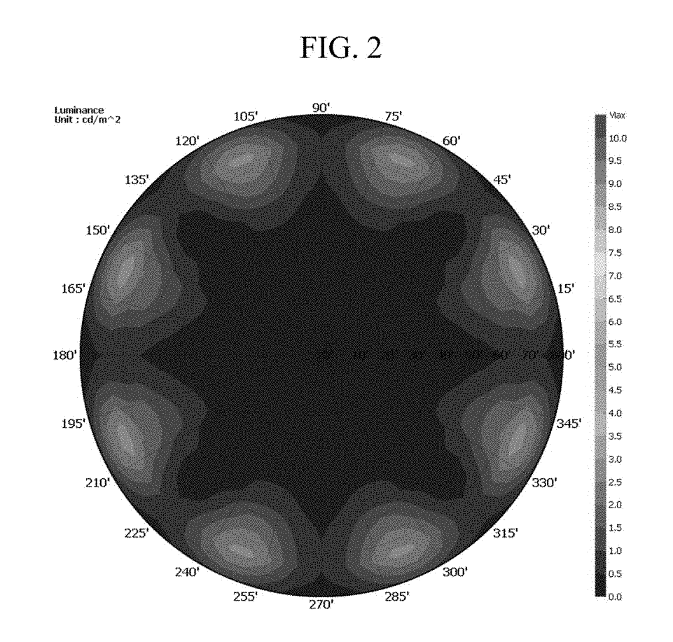

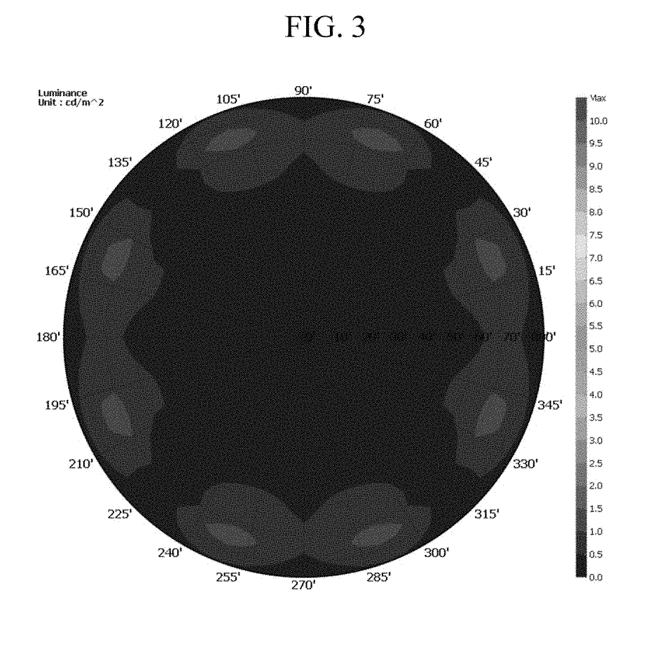

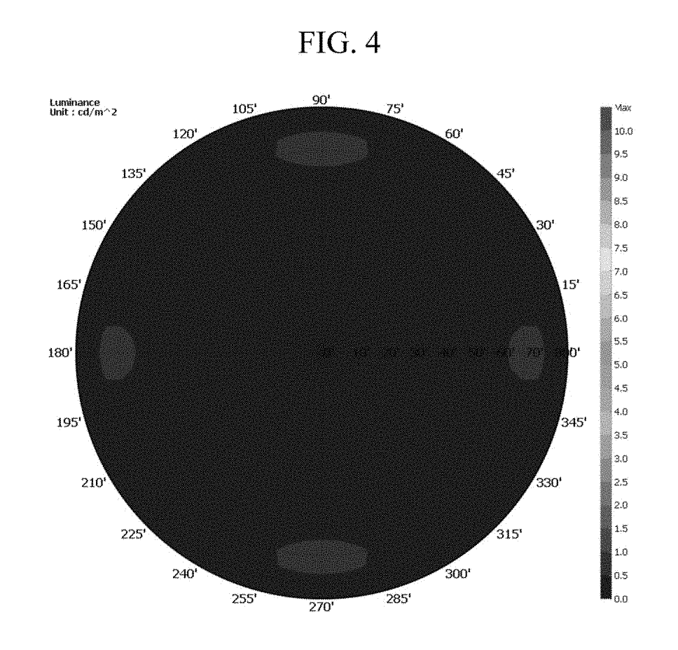

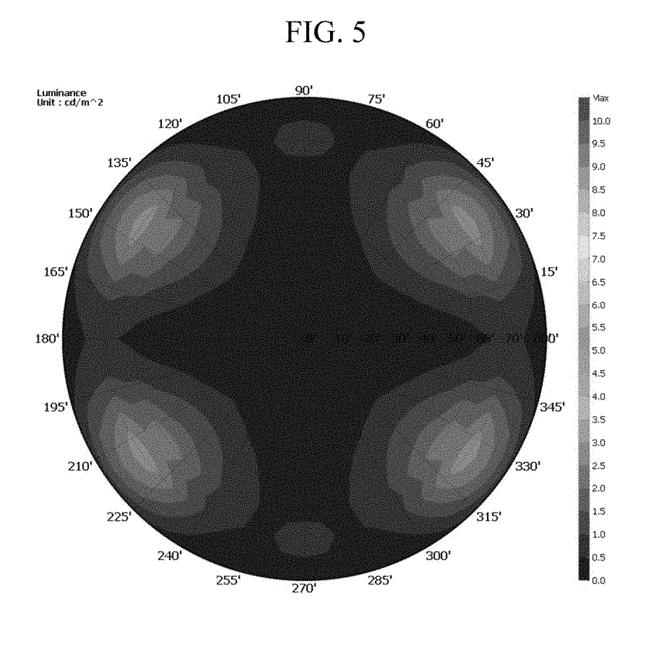

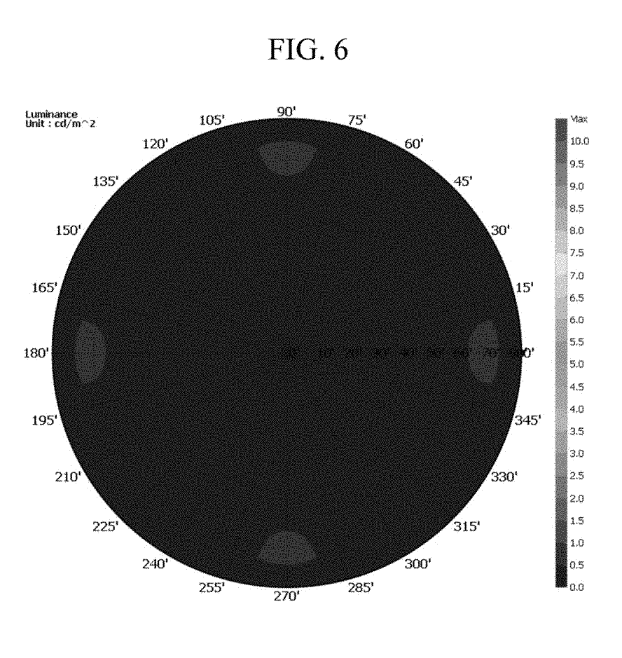

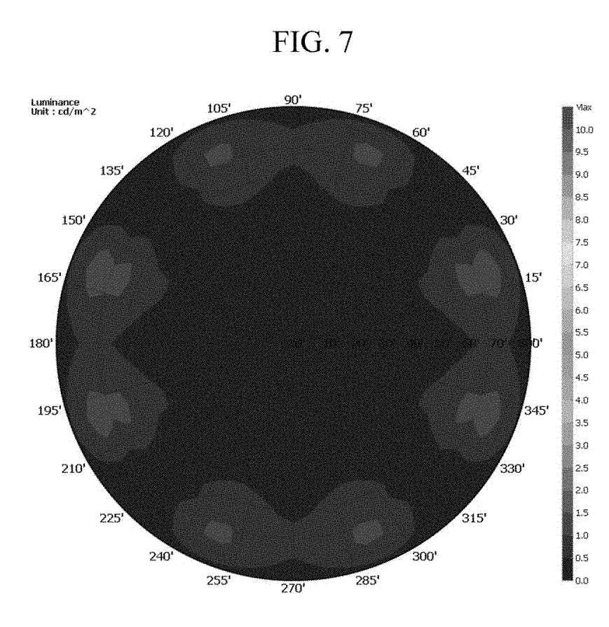

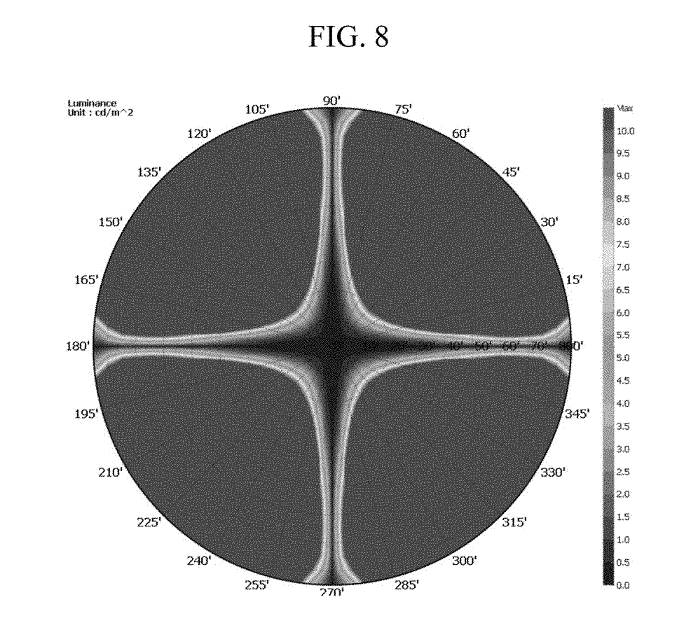

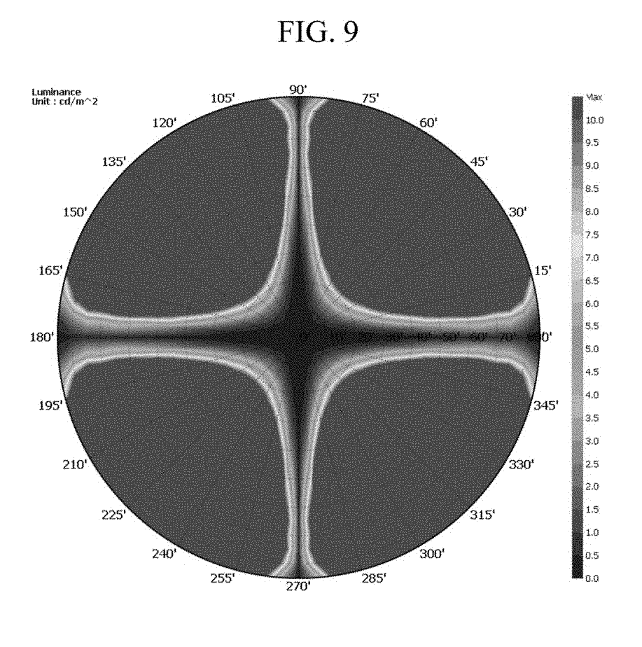

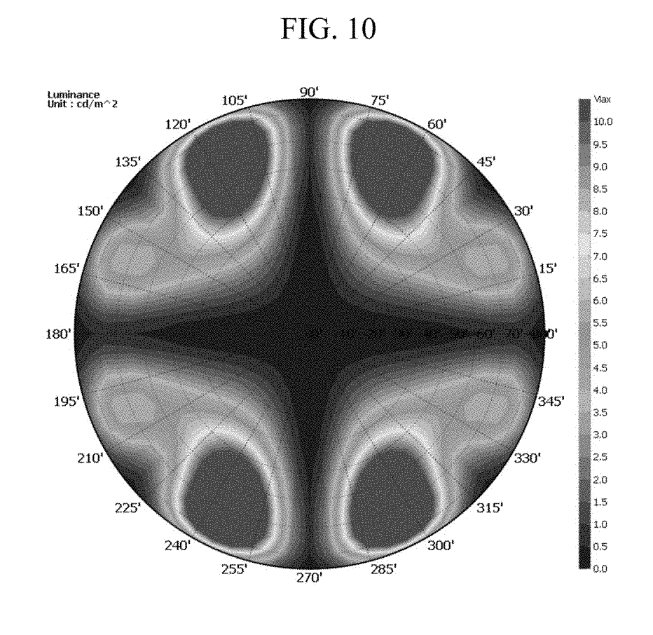

FIG. 2 is a color diagram showing a distribution of luminance in a dark state of the liquid crystal display (LCD) according to Example 15, FIG. 3 is a color diagram showing a distribution of luminance in a dark state of the liquid crystal display (LCD) according to Example 23, FIG. 4 is a color diagram showing a distribution of luminance in a dark state of the liquid crystal display (LCD) according to Example 31,FIG. 5 is a color diagram showing a distribution of luminance in a dark state of the liquid crystal display (LCD) according to Example 44, FIG. 6 is a color diagram showing a distribution of luminance in a dark state of the liquid crystal display (LCD) according to Example 46, FIG. 7 is a color diagram showing a distribution of luminance in a dark state of the liquid crystal display (LCD) according to Example 49, FIG. 8 is a color diagram showing a distribution of luminance in a dark state of the liquid crystal display (LCD) according to Comparative Example 1, FIG. 9 is a color diagram showing a distribution of luminance in a dark state of the liquid crystal display (LCD) according to Comparative Example 2, and FIG. 10 is a color diagram showing a distribution of luminance in a dark state of the liquid crystal display (LCD) according to Comparative Example 3.

TABLE 1

| | Upper phase | | Lower phase | | Average | Relative |
|---|---|---|---|---|---|---|
| | difference | | difference | | luminance | to |
| | layer | | layer | | in a | Comparative |
| | Rᵢₙ₁ | Rₜₕ₁ | Rᵢₙ₂ | Rₜₕ₂ | dark state | Example 2 |
| | (nm) | (nm) | (nm) | (nm) | (cd/m²) | (%) |
| Comp. | — | — | — | — | 101.392 | 174 |
| Ex. 1 | | | | | | |
| Comp. | — | — | 120 | 60 | 58.27 | 100% |
| Ex. 2 | | | | | | (ref.) |
| Ex. 1 | 30 | 270 | 10 | 5 | 1.992 | 3.4 |
| Ex. 2 | 50 | 278 | 10 | 5 | 1.855 | 3.2 |
| Ex. 3 | 50 | 250 | 10 | 5 | 1.197 | 2.1 |
| Ex. 4 | 45 | 258 | 10 | 5 | 1.006 | 1.7 |
| Ex. 5 | 65 | 255 | 10 | 5 | 2.774 | 4.8 |
| Ex. 6 | 30 | 250 | 30 | 15 | 1.564 | 2.7 |
| Ex. 7 | 50 | 258 | 30 | 15 | 1.594 | 2.7 |
| Ex. 8 | 50 | 230 | 30 | 15 | 1.036 | 1.8 |
| Ex. 9 | 60 | 240 | 30 | 15 | 1.869 | 3.2 |
| Ex. 10 | 43 | 239 | 30 | 15 | 0.790 | 1.4 |
| Ex. 11 | 60 | 200 | 50 | 25 | 2.264 | 3.9 |
| Ex. 12 | 20 | 240 | 50 | 25 | 2.117 | 3.6 |
| Ex. 13 | 40 | 192 | 50 | 25 | 1.973 | 3.4 |
| Ex. 14 | 40 | 248 | 50 | 25 | 1.594 | 2.7 |
| Ex. 15 | 40 | 220 | 50 | 25 | 0.555 | 1.0 |
| Ex. 16 | 40 | 222 | 50 | 25 | 0.546 | 0.9 |
| Ex. 17 | 50 | 180 | 70 | 35 | 2.107 | 3.6 |
| Ex. 18 | 10 | 220 | 70 | 35 | 1.917 | 3.3 |
| Ex. 19 | 50 | 220 | 70 | 35 | 1.692 | 2.9 |
| Ex. 20 | 58 | 200 | 70 | 35 | 2.360 | 4.1 |
| Ex. 21 | 30 | 228 | 70 | 35 | 0.804 | 1.4 |
| Ex. 22 | 30 | 200 | 70 | 35 | 0.550 | 0.9 |
| Ex. 23 | 33 | 210 | 70 | 35 | 0.326 | 0.6 |
| Ex. 24 | 34 | 203 | 70 | 35 | 0.401 | 0.7 |
| Ex. 25 | 10 | 180 | 90 | 45 | 1.850 | 3.2 |
| Ex. 26 | 50 | 180 | 90 | 45 | 2.569 | 4.4 |
| Ex. 27 | 10 | 220 | 90 | 45 | 0.830 | 1.4 |
| Ex. 28 | 30 | 172 | 90 | 45 | 1.647 | 2.8 |
| Ex. 29 | 30 | 228 | 90 | 45 | 1.602 | 2.7 |
| Ex. 30 | 30 | 200 | 90 | 45 | 0.392 | 0.7 |
| Ex. 31 | 22 | 204 | 90 | 45 | 0.210 | 0.4 |
| Ex. 32 | 10 | 180 | 100 | 50 | 1.279 | 2.2 |
| Ex. 33 | 10 | 220 | 100 | 50 | 0.653 | 1.1 |
| Ex. 34 | 30 | 172 | 100 | 50 | 1.658 | 2.8 |
| Ex. 35 | 30 | 228 | 100 | 50 | 2.329 | 4.0 |
| Ex. 36 | 30 | 200 | 100 | 50 | 0.775 | 1.3 |
| Ex. 37 | 16 | 203 | 100 | 50 | 0.211 | 0.4 |
| Ex. 38 | 10 | 185 | 110 | 55 | 0.819 | 1.4 |
| Ex. 39 | 10 | 215 | 110 | 55 | 0.431 | 0.7 |
| Ex. 40 | 25 | 179 | 110 | 55 | 1.434 | 2.5 |
| Ex. 41 | 25 | 221 | 110 | 55 | 1.861 | 3.2 |
| Ex. 42 | 25 | 200 | 110 | 55 | 0.951 | 1.6 |

TABLE 2

| | | | | | Average | |
|---|---|---|---|---|---|---|
| | Upper phase | | Lower phase | | luminance | Relative to |
| | difference layer | | difference layer | | in a | Comparative |
| | Rin1 | Rth1 | Rin2 | Rth2 | dark state | Example 3 |
| | (nm) | (nm) | (nm) | (nm) | (cd/m²) | (%) |
| Comp. | — | — | — | — | 101.392 | 3111 |
| Ex. 1 | | | | | | |
| Comp. | — | — | 65 | 250 | 3.259 | 100% (ref.) |
| Ex. 3 | | | | | | |
| Ex. 43 | 45 | 120 | 45 | 120 | 0.695 | 21 |
| Ex. 44 | 55 | 130 | 35 | 115 | 0.590 | 18 |
| Ex. 45 | 35 | 115 | 55 | 130 | 0.620 | 19 |
| Ex. 46 | 40 | 130 | 40 | 130 | 0.206 | 6 |
| Ex. 47 | 30 | 120 | 50 | 140 | 0.264 | 8 |
| Ex. 48 | 50 | 140 | 30 | 120 | 0.241 | 7 |
| Ex. 49 | 30 | 100 | 50 | 160 | 0.341 | 10 |
| Ex. 50 | 50 | 160 | 30 | 100 | 0.308 | 9 |
| Ex. 51 | 20 | 80 | 60 | 180 | 0.795 | 24 |
| Ex. 52 | 20 | 60 | 60 | 200 | 1.074 | 33 |
| Ex. 53 | 20 | 45 | 60 | 225 | 1.568 | 48 |
| Ex. 54 | 60 | 225 | 20 | 45 | 1.187 | 36 |
| Ex. 55 | 80 | 170 | 10 | 90 | 1.975 | 61 |
| Ex. 56 | 80 | 70 | 10 | 190 | 0.435 | 13 |
| Ex. 57 | 70 | 60 | 20 | 200 | 0.447 | 14 |
| Ex. 58 | 70 | 50 | 20 | 210 | 0.614 | 19 |
| Ex. 59 | 90 | 60 | 10 | 200 | 0.363 | 11 |
| Ex. 60 | 100 | 60 | 10 | 200 | 0.267 | 8 |
| Ex. 61 | 120 | 80 | 10 | 180 | 1.413 | 43 |
| Ex. 62 | 10 | 180 | 120 | 80 | 2.067 | 63 |

Referring to Tables 1 and 2, and FIGS. 2 to 10, the liquid crystal displays (LCD) according to the Examples maintain low luminance in a dark state at all the azimuthal angles and all the side angles and thus show a high contrast ratio compared with the liquid crystal displays (LCD) according to the Comparative Examples. Thus, LCDs according to the Examples may be expected to have a higher contrast ratio than LCDs according to the Comparative Examples.

While this disclosure has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display, comprising:
a lower substrate and an upper substrate which face each other, a liquid crystal layer between the lower substrate and the upper substrate,
a color conversion layer on the liquid crystal layer,
a first polarizing layer and a first phase difference layer between the liquid crystal layer and the color conversion layer, and
a second polarizing layer and a second phase difference layer between a light source and the lower substrate,
wherein the first phase difference layer has refractive indexes satisfying Relationship Equation 1, and
the second phase difference layer has refractive indexes satisfying Relationship Equation 2:
nₓ₁>n_{y1}>n_{z1,} Relationship Equation 1
in Relationship Equation 1,
nₓ₁ is a refractive index at a slow axis of the first phase difference layer,
n_{y1} is a refractive index at a fast axis of the first phase difference layer, and
n_{z1} i is a refractive index in a direction perpendicular to the slow axis and the fast axis of the first phase difference layer, and
nₓ₂>n_{y2}≥n_{z2}, Relationship Equation 2
in Relationship Equation 2,
nₓ₂ is a refractive index at a slow axis of the second phase difference layer,
n_{y2} is a refractive index at a fast axis of the second phase difference layer, and
n_{z2} is a refractive index in a direction perpendicular to the slow axis and the fast axis of the second phase difference layer.

2. The liquid crystal display of claim 1, wherein the first phase difference layer has a retardation satisfying Relationship Equation 3:
45 nanometers≤Rₜₕ₁ (450 nm)≤280 nanometers, Relationship Equation 3
in Relationship Equation 3,
Rₜₕ₁ (450 nm) is a thickness direction retardation of the first phase difference layer at a wavelength of 450 nanometers.

3. The liquid crystal display of claim 2, wherein the first phase difference layer has a retardation satisfying Relationship Equation 4:
10 nanometers≤Rᵢₙ₁ (450 nm) 120 nanometers, Relationship Equation 4
in Relationship Equation 4,
Rᵢₙ₁ (450 nm) is an in-plane retardation of the first phase difference layer at the wavelength of 450 nanometers.

4. The liquid crystal display of claim 1, wherein the second phase difference layer has a retardation satisfying Relationship Equation 5:
10 nanometers≤Rᵢₙ₂(450 nm)≤120 nanometers, Relationship Equation 5
in Relationship Equation 5,
Rᵢₙ₂ (450 nm) is an in-plane retardation of the second phase difference layer at a wavelength of 450 nanometers.

5. The liquid crystal display of claim 4, wherein the second phase difference layer has a retardation satisfying Relationship Equation 6:
5 nanometers≤Rₜₕ₂ (450 nm)≤250 nanometers, Relationship Equation 6
in Relationship Equation 6,
Rₜₕ₂ (450 nm) is a thickness direction retardation of the second phase difference layer at the wavelength of 450 nanometers.

6. The liquid crystal display of claim 1, wherein the refractive indexes of the second phase difference layer satisfy Relationship Equation 2a and the second phase difference layer has retardations satisfying Relationship Equation 7a:
nₓ₂>n_{y2}=n_{z2}, Relationship Equation 2a
, and
Rₜₕ₂ (450 nm)/Rᵢₙ₂ (450 nm)<1, Relationship Equation 7a
in Relationship Equation 7a,
Rᵢₙ₂ (450 nm) is an in-plane retardation of the second phase difference layer at a wavelength of 450 nanometers, and
Rₜₕ₂ (450 nm) is a thickness direction retardation of the second phase difference layer at the wavelength of 450 nanometers.

7. The liquid crystal display of claim 1, wherein the refractive indexes of the second phase difference layer satisfy Relationship Equation 2b:
nₓ₂>n_{y2}>n_{z2.} Relationship Equation 2b

8. The liquid crystal display of claim 1, wherein the first phase difference layer is positioned between the liquid crystal layer and the first polarizing layer, and
the second phase difference layer is positioned between the lower substrate and the second polarizing layer.

9. The liquid crystal display of claim 1, wherein the color conversion layer comprises a light emitting element which receives a first visible light from the light source and emits a second visible light.

10. The liquid crystal display of claim 9, wherein the first visible light is blue light and
the second visible light is blue light, green light, red light, or a combination thereof.

11. The liquid crystal display of claim 9, wherein the light emitting element comprises a quantum dot, a phosphor, or a combination thereof.

12. The liquid crystal display of claim 1, wherein the liquid crystal layer comprises liquid crystals having negative birefringence.

13. The liquid crystal display of claim 12, wherein the liquid crystal layer has a retardation satisfying Relationship Equation 8:
−360 nanometers≤Rₜₕ_{₁₃}_{cell}≤−250 nanometers Relationship Equation 8
in Relationship Equation 8,
Rₜₕ_{_}_{cell} is a thickness direction retardation of the liquid crystal layer.

14. A liquid crystal display, comprising:
a first phase difference layer and a second phase difference layer,
wherein one of the first phase difference layer and the second phase difference layer is inside a liquid crystal display panel,
the other of the first phase difference layer and the second phase difference layer is outside the liquid crystal display panel,
the first phase difference layer has refractive indexes satisfying Relationship Equation 1,
the second phase difference layer has refractive indexes satisfying Relationship Equation 2:
nₓ₁>n_{y1}>n_{z1,} Relationship Equation 1
in Relationship Equation 1,
nₓ₁ is a refractive index at a slow axis of the first phase difference layer,
n_{y1} is a refractive index at a fast axis of the first phase difference layer, and
n_{z1} is a refractive index in a direction perpendicular to the slow axis and the fast axis of the first phase difference layer, and
nₓ₂>n_{y2}>n_{z2,} Relationship Equation 2
in Relationship Equation 2,
nₓ₂ is a refractive index at a slow axis of the second phase difference layer,
n_{y2} is a refractive index at a fast axis of the second phase difference layer, and
n_{z2} is a refractive index in a direction perpendicular to the slow axis and the fast axis of the second phase difference layer.

15. The liquid crystal display of claim 14, wherein the first phase difference layer has a retardation satisfying Relationship Equation 3, and the second phase difference layer has a retardation satisfying Relationship Equation 5:
45 nanometers≤Rₜₕ₁ (450 nm)≤280 nanometers, and Relationship Equation 3
10 nanometers≤Rᵢₙ₂ (450 nm)≤120 nanometers, Relationship Equation 5
in Relationship Equation 3 or 5,
Rₜₕ₁ (450 nm) is a thickness direction retardation of the first phase difference layer at a wavelength of 450 nanometers, and
Rᵢₙ₂ (450 nm) is an in-plane retardation of the second phase difference layer at the wavelength of 450 nanometers.

16. The liquid crystal display of claim 14, wherein the refractive indexes of the second phase difference layer satisfy Relationship Equation 2a and the second phase difference layer has retardations satisfying Relationship Equation 7a:
nₓ₂>n_{y2}=n_{z2} Relationship Equation 2a
, and
Rₜₕ₂ (450 nm)/Rᵢₙ₂ (450 nm)< Relationship Equation 7a
in Relationship Equation 7a,
Rᵢₙ₂ (450 nm) is an in-plane retardation of the second phase difference layer at a wavelength of 450 nanometers, and
Rₜₕ₂ (450 nm) is a thickness direction retardation of the second phase difference layer at the wavelength of 450 nanometers.

17. The liquid crystal display of claim 14, wherein the refractive indexes of the second phase difference layer satisfy Relationship Equation 2b:
nₓ₂>n_{y2}>n_{z2} Relationship Equation 2b

18. The liquid crystal display of claim 14, wherein the liquid crystal display panel comprises:
a lower substrate and an upper substrate which face each other,
to a liquid crystal layer between the lower substrate and the upper substrate and which comprises liquid crystals having negative birefringence, and
a color conversion layer on the liquid crystal layer and which comprises a light emitting element,
wherein the first phase difference layer is positioned between the liquid crystal layer and the color conversion layer inside the liquid crystal display panel.

19. The liquid crystal display of claim 18, wherein the liquid crystal display panel further comprises a first polarizing layer between the first phase difference layer and the color conversion layer.

20. The liquid crystal display of claim 19, further comprising a second polarizing layer positioned on or under the second phase difference layer and wherein the second phase difference layer is outside the liquid crystal display panel.
